(19) United States
(12) Patent Application Publication
(10) Pub. No.: US 2011/0219454 A1
(43) Pub. Date: Sep. 8, 2011

(54) METHODS OF IDENTIFYING ACTIVEX CONTROL DISTRIBUTION SITE, DETECTING SECURITY VULNERABILITY IN ACTIVEX CONTROL AND IMMUNIZING THE SAME

(75) Inventors: Cheol Ho LEE, Daejeon (KR); Dong Hyun LEE, Daejeon (KR); Soo Yong KIM, Deajeon (KR); Hyung Geun OH, Daejeon (KR)

(73) Assignee: ELECTRONICS AND TELECOMMUNICATIONS RESEARCH INSTITUTE, Daejeon (KR)

(21) Appl. No.: 12/944,050

(22) Filed: Nov. 11, 2010

(30) Foreign Application Priority Data
Mar. 5, 2010 (KR) 10-2010-0019869

(51) Int. Cl. G06F 11/00; G06F 17/30

(52) U.S. Cl. 726/25; 707/706; 707/E17.108

(57) ABSTRACT

Provided is a method of identifying an ActiveX control distribution site, detecting a security vulnerability in an ActiveX control and immunizing the same. A security vulnerability existing in an ActiveX control may be automatically detected, effects brought on by the corresponding security vulnerability may be measured, and abuse of the detected security vulnerability in a user PC to be protected may be immediately prevented. Therefore, since the user PC may be protected regardless of a security patch, it is anticipated that security problems in the Internet environment caused by imprudent use of the ActiveX control may be significantly enhanced.

### CROSS-REFERENCE TO RELATED APPLICATION

This application claims priority to and the benefit of Korean Patent Application No. 10-2010-0019869, filed Mar. 5, 2010, the disclosure of which is incorporated herein by reference in its entirety.

### BACKGROUND

1. Field of the Invention

The present invention relates to a method of identifying an ActiveX control distribution site, a method of detecting a security vulnerability in an ActiveX control, and a method of immunizing the same, and more specifically, to a method of automatically detecting a security vulnerability by recognizing a distribution status of an ActiveX control installed from a website to operate on a user PC, and immediately immunizing the detected security vulnerability.

2. Discussion of Related Art

ActiveX controls are mainly based on Microsoft's component object model (COM) technology, and thus security restrictions on the operation of the controls are limited. Therefore, secure ActiveX controls can be obtained only when a developer establishes a development rule in consideration of security by himself or herself and develops ActiveX controls according to the rule. For these reasons, a number of ActiveX controls have significant security vulnerability to buffer overflow, file writing, file deleting, registry editing, automatic updating, and execution of arbitrary commands.

In addition, such security vulnerability in the ActiveX controls may come into full control of a user PC without the user's awareness when a malicious web page or a spam mail installed by a malicious attacker is clicked, so that malicious code such as Bots can be installed. In particular, an ActiveX control is directly installed in a user PC accessing a distribution web site, and thus when the security vulnerability exists in the ActiveX control used in large portal sites, shopping mall sites, public agency sites dealing with civil services, etc., which are accessed by many users, it may result in serious problems such as a great number of zombie PCs.

Further, when the development and distribution of a security patch for the security vulnerability in an ActiveX control are delayed after the security vulnerability is announced, millions of or tens of millions of PCs with the ActiveX control may be completely vulnerable to a zero-day attack.

Testing tools such as Dranzer (CERT/CC in U.S.), COMRaider, AxMan, COMbust, and AxFuzz have been developed as a means to supplement the security vulnerability in the ActiveX control. However, such testing tools have a low level of automation for testing, and the security vulnerability type of an object to be tested is limited to buffer overflow. In addition, in the testing tools, an input value used for security vulnerability test is not relatively freely adjusted, and a test using the Internet Explorer having the same environment as actually used is not performed.

That is, while effects brought on by the corresponding security vulnerability are measured in addition to the security vulnerability in the ActiveX control being automatically tested to develop a security patch and determine the priority in application of the same, and to estimate the possible damage that may be caused under the worst circumstances, there is no substantial technology capable of measuring the effects.

Moreover, while it is necessary to take measures to remove the found security vulnerability or to take measures to prevent abuse of the security vulnerability, development of a security patch is completely depended upon, and thus further innovative measures capable of preventing abuse of security vulnerability are required.

### SUMMARY OF THE INVENTION

The present invention is directed to a method of recognizing a distribution status of an ActiveX control, a method of automatically detecting a security vulnerability in an ActiveX control, and a method of immediately immunizing the detected security vulnerability.

More specifically, the present invention is also directed to a method of identifying an ActiveX control distribution site capable of (1) recognizing the distribution status of an ActiveX control, (2) measuring effects brought on by a security vulnerability in the ActiveX control, and (3) identifying an ActiveX control distribution site by which an application status of a security patch may be recognized.

The present invention is further directed to a method of detecting a security vulnerability in an ActiveX control capable of (1) conducting a test on the basis of the Internet Explorer having the same environmental conditions as actually used, (2) applying test input values of various patterns, (3) detecting a security vulnerability in a resource access format in addition to buffer overflow, and (4) automatically generating an exploit pattern for the detected security vulnerability.

The present invention is further directed to a method of immunizing a security vulnerability in an ActiveX control capable of (1) being executable in a user PC, (2) using an ActiveX control security vulnerability detection result as a detection pattern, (3) monitoring a function call of an ActiveX control, and (4) blocking a function call of an ActiveX control using an exploit pattern.

An aspect of the present invention provides a method of identifying an ActiveX control distribution site including: performing a search engine query input from a distribution site identification server to obtain URLs to be tested, and executing a web browser for each of the obtained URLs to be tested to access the URLs to be tested; determining whether or not each of the accessed URLs to be tested uses an ActiveX control; collecting information on the corresponding ActiveX control and recording the collected information in a distribution status DB when each accessed URL uses an ActiveX control; and identifying the ActiveX control distribution site based on the distribution status DB.

Another aspect of the present invention provides a method of detecting a security vulnerability in an ActiveX control including: installing an ActiveX control to be tested from a security vulnerability detection server to a testing PC that operates in a virtual machine; generating combinations of test input values for testing the corresponding ActiveX control; generating a test web page using the generated combinations of test input values; executing a web browser to access the generated test web page, monitoring activities of the web browser, and recording a debugging log caused by abnormal termination of the web browser and a resource access log caused by a resource access in a security vulnerability DB; and detecting a security vulnerability in the corresponding ActiveX control based on the security vulnerability DB.

Still another aspect of the present invention provides a method of immunizing an ActiveX control including: updating an exploit pattern DB in which an exploit pattern that is an abnormal use pattern of an ActiveX control at a user PC is recorded, and hooking a function call path of an ActiveX control to be monitored; monitoring a call of a function of the ActiveX control to be monitored using the hooked code; measuring a degree of similarity between a transfer factor and the exploit pattern with respect to each function call when the function call of the ActiveX control to be monitored is made; determining use of the exploit pattern and interrupting the function call when the measured degree of similarity exceeds a predefined threshold, and determining non-use of the exploit pattern and allowing the function call when the measured degree of similarity does not exceed a predefined threshold; and collecting information on abuse of a vulnerability, and transferring the collected information to a security vulnerability detection server when the use of the exploit pattern causes the function call to be blocked.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic diagram illustrating a process of identifying an ActiveX control distribution site, detecting a security vulnerability in an ActiveX control and immunizing the security vulnerability according to an exemplary embodiment of the present invention;

FIG. 2 illustrates a process of identifying an ActiveX control distribution site according to an exemplary embodiment of the present invention;

FIG. 3 illustrates an example of a distribution status DB used in the present invention;

FIG. 4 illustrates a process of detecting a security vulnerability in an ActiveX control according to an exemplary embodiment of the present invention;

FIGS. 5A and 5B illustrate an example of a control-specific input value DB and a basic input value DB used in the present invention;

FIG. 6 illustrates an example of a security vulnerability DB used in the present invention;

FIG. 7 illustrates a process of immunizing a security vulnerability in an ActiveX control according to an exemplary embodiment of the present invention;

FIG. 8 illustrates an example of an exploit pattern DB used in the present invention; and

FIG. 9 illustrates an example of a vulnerability abuse site DB used in the present invention.

### DETAILED DESCRIPTION OF EXEMPLARY EMBODIMENTS

The present invention will be described more fully hereinafter with reference to the accompanying drawings, in which exemplary embodiments of the invention are shown, such that one skilled in the art could have easily embody the invention. In the following description of the present invention, a detailed description of known functions and components incorporated herein will be omitted when it may make the subject matter of the present invention rather unclear.

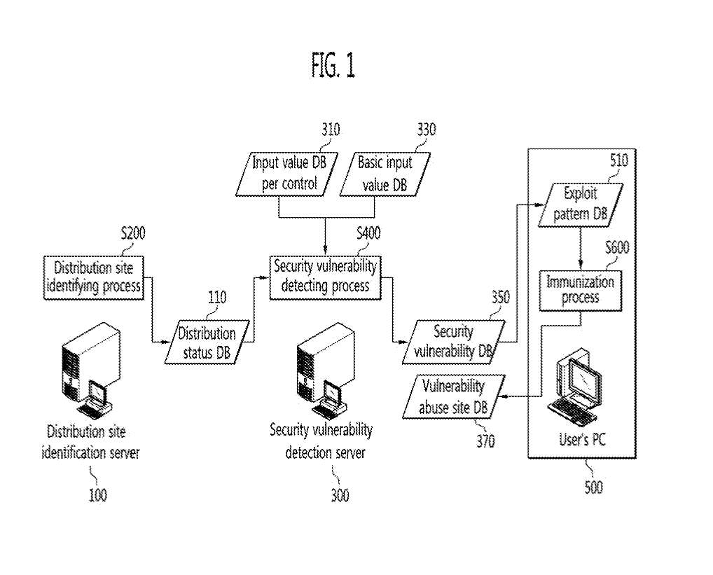

FIG. 1 is a schematic diagram illustrating a process of identifying an ActiveX control distribution site, a process of detecting a security vulnerability in an ActiveX control, and a process of immunizing the ActiveX control according to an exemplary embodiment of the present invention.

Referring to FIG. 1, a process of identifying an ActiveX control distribution site (S200), a process of detecting a security vulnerability in an ActiveX control (S400) and a process of immunizing the ActiveX control (S600) according to an exemplary embodiment of the present invention may be applied to one system to interwork with one another.

First, a distribution site identification server 100 performs the distribution site identifying process (S200) to record information on the identified ActiveX control in a distribution status database (DB) 110.

Next, a security vulnerability detection server 300 performs the security vulnerability detecting process (S400) based on the distribution status DB 110, and records information on the detected security vulnerability in a security vulnerability DB 350.

In this case, the security vulnerability detection server 300 receives a control-specific input value DB 310 and a basic input value DB 330 as method transfer factors required for a test and performs the security vulnerability detecting process (S400).

Here, the security vulnerability DB 350 includes an exploit pattern of the ActiveX control to be blocked for security. Further, the security vulnerability DB 350 and the exploit pattern included therein will be described in greater detail below.

Next, a user PC 500 updates an exploit pattern DB 510 stored in a memory using the exploit pattern included in the security vulnerability DB 350, and then performs the immunization process (S600) based on the updated exploit pattern DB 510.

The distribution site identifying process (S200), the security vulnerability detecting process (S400) and the immunization process (S600) will be described in greater detail below.

(1) ActiveX Control Distribution Site Identifying Process (S200)

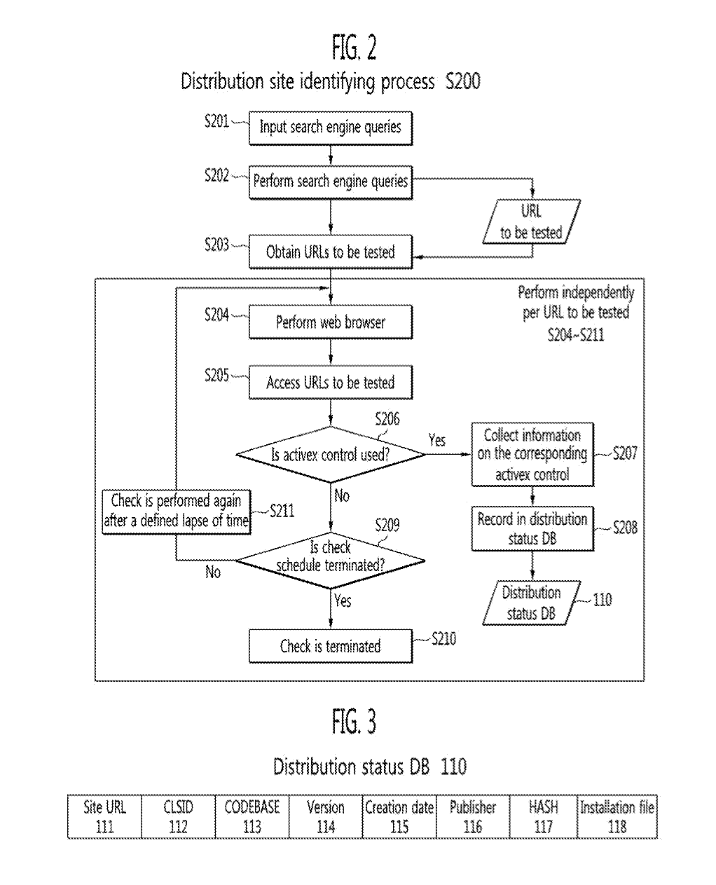

FIG. 2 illustrates the ActiveX control distribution site identifying process (S200) according to an exemplary embodiment of the present invention.

First, search engine queries are input by a user (S201).

In this case, a type of a domain or a site to be tested is designated by the search engine query through a search query (e.g., site:domain.com) supported by a search engine such as Google.

The search engine queries are then performed (S202) to obtain URLs to be tested (S203)

Next, a web browser is executed on each of the obtained URLs (S204) to access the URLs to be tested (S205).

Then, a structure of a document object model (DOM) loaded into the web browser in the accessed URLs to be tested is analyzed to determine whether an ActiveX control is used or not (S206).

When an ActiveX control is used, information on the ActiveX control is collected (S207) and recorded in the distribution status DB 110 (S208).

The distribution status DB 110 will be described in greater detail below.

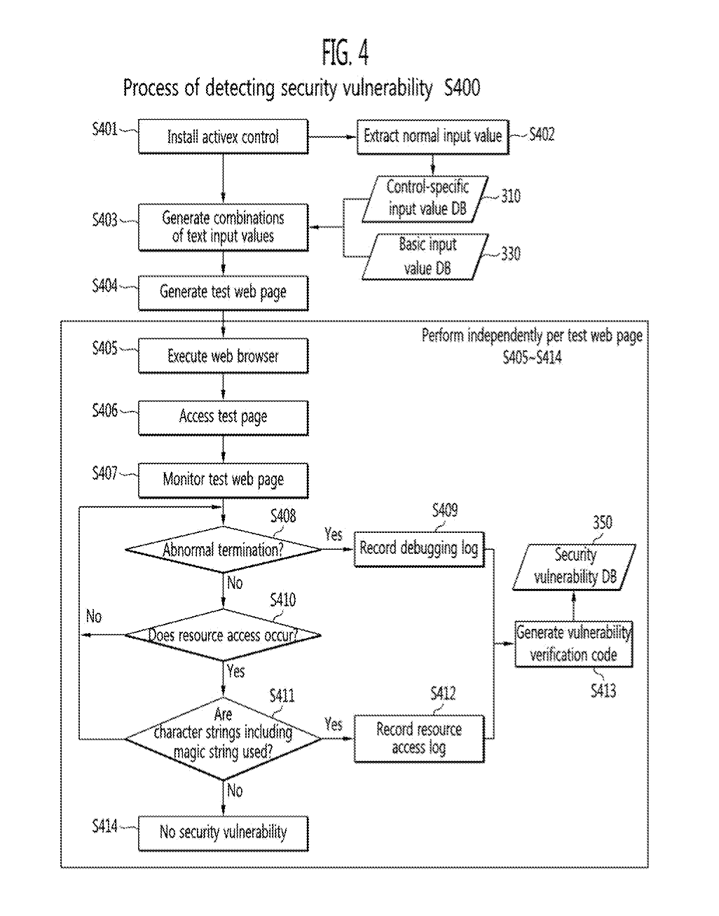

FIG. 3 illustrates an example of a distribution status DB used in the present invention.

Referring to FIG. 3, a site URL 111 on which an ActiveX control is used, CLSID 112 of the ActiveX control, CODEBASE 113, a version 114, a creation date 115, a publisher 116, HASH 117, an installation file 118, etc. are recorded in the distribution status DB 110.

Here, the CLSID 112 denotes an identifier (ID) of the ActiveX control, and the CODEBASE 113 denotes an installation file URL of the ActiveX control.

The same ActiveX control is distributed in several versions, and thus information such as a version 114, a creation date 115, and a publisher 116 of the ActiveX control is recorded in the distribution status DB 110 to identify each version.

Moreover, in order to overcome ambiguous identification attributable to a mismanaged version of the ActiveX control, hash values 117 for all installation files are recorded in the distribution status DB 110, and the installation file 118 is recorded in the distribution status DB 110 in a binary manner for the security vulnerability detecting process (S400).

Referring back to FIG. 2, when it is determined in S206 that an ActiveX control is not used, it is tested whether a test scheduling is terminated or not (S209). When the test scheduling is terminated, the test is terminated (S210), and when the test scheduling is not terminated, the test is performed again after a designated time lapses (S211).

That is, in the distribution site identifying process (S200), URLs to be tested are obtained through the search engine queries, and whether each of the URLs uses an ActiveX control or not is detected through web browser access to recognize the distribution status. In addition, the testing tasks for the URLs to be tested are managed using single schedule, and information on the ActiveX control distributed by the same URL is collected periodically to update the distribution status DB 110.

Therefore, according to the distribution site identifying process (S200), an ActiveX control distribution status, and a security patch application status can be promptly recognized. Furthermore, effects that may be brought on by the security vulnerability in the ActiveX control can be measured.

(2) ActiveX Control Security Vulnerability Detecting Process (S400)

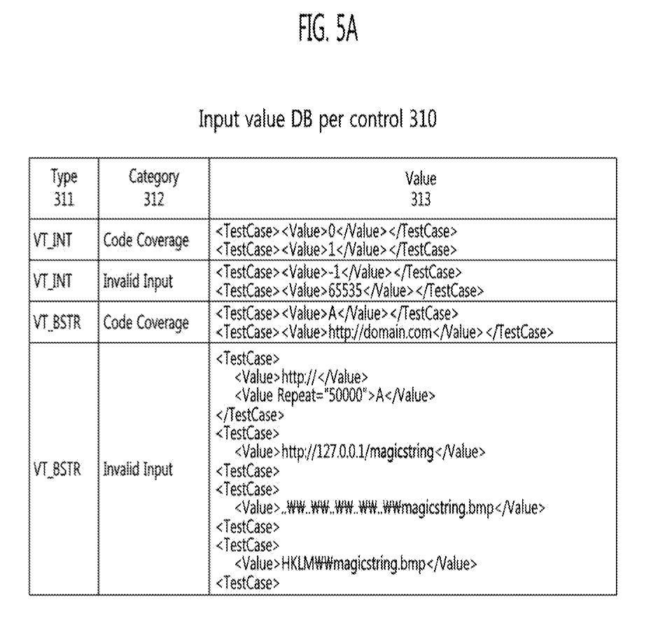

FIG. 4 illustrates a process of detecting a security vulnerability in an ActiveX control (S400) according to an exemplary embodiment of the present invention.

First, an ActiveX control to be tested is installed on a testing PC that operates in a virtual machine (S401).

In this case, the ActiveX control to be tested is installed using information on the CLSID 112 and the installation file 118 in the distribution status DB 110.

Next, a normal input value for each method and transfer factor is extracted from a normal website that uses the ActiveX control to be tested and is recorded in a control-specific input value DB 310 (S402).

In this case, a function call (a method call, a property call, and input of an initial value for initialization) path of the ActiveX control is utilized to extract the normal input value for each method and transfer factor using a technical method such as hooking. The normal input value extracting step (S402) may be omitted as necessary.

Combinations of text input values for testing the corresponding ActiveX control are then created (S403).

In this case, the combinations of test input values are created for each callable method, property, and initialization. When a method has two or more transfer factors, various combinations of test input values may be created depending on the type of each transfer factor.

Here, the test input value is input from a control-specific input value DB 310 built through the normal input value extracting step (S402) and a predefined basic input value DB 330.

The control-specific input value DB 310 and the basic input value DB 330 will be described in greater detail below.

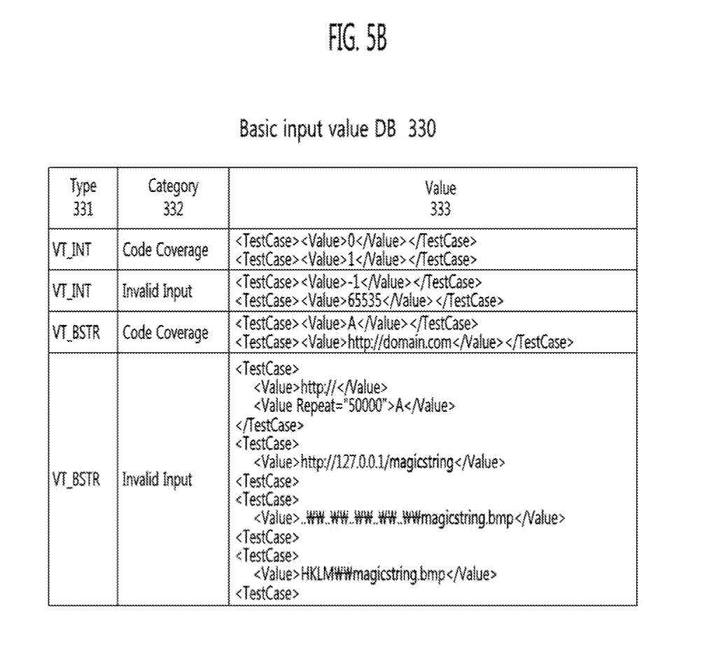

FIGS. 5A and 5B illustrate an example of the control-specific input value DB 310 and the basic input value DB 330 used in the present invention.

“magicstring” was used to detect a resource access-type security vulnerability, “http://magicstring.com” was used to detect a network access security vulnerability, and “c:\\magicstring.bmp” was used to detect a file access security vulnerability.

Referring to FIGS. 5A and 5B, information such as Types 311 and 331, Categories 312 and 332, and Values 313 and 333 is recorded in the control-specific input value DB 310 and the basic input value DB 330.

Types 311 and 331 denote input value types of an ActiveX control, and support every standard data type that the ActiveX control may have.

Categories 312 and 332 denote test input values for testing the ActiveX control, each being classified into Code Coverage and Invalid Input depending on the use.

Here, Invalid Input is an input value having an extreme value that is not used under normal circumstances so that the presence of the security vulnerability can be determined. Code Coverage is a value forming every condition enabling entry up to a code point where the security vulnerability occurs due to the Invalid Input value.

For example, it is assumed that a method used in the form of method1(1, “a”) or method1(2, “ab”) under normal circumstances is implemented in a form as shown in [Example 1].

### Example 1

bool method(int length, char* string)
{

charbuffer[128];
if (length > 128) return(false);
strcpy(buffer, string);
...
return(true);

}

In the method such as [Example 1], a first transfer factor represents the length of a second transfer factor, and the second transfer factor is copied onto an address of a memory stack by an internally vulnerable function strcpy( ).

When a call of method1 is performed as method1(1,“AAAAAA . . . AAAAAA”);, a security vulnerability in which buffer overflow is generated may be observed. Therefore, the first transfer factor “1” used for the call may be regarded as Code Coverage, and the second transfer factor “AAAAAA . . . AAA” may be regarded as Invalid Input.

Values 313 and 333 denote values structured in an XML form, and [Example 2] shows a long character string in an http://AAAA . . . AAAA form represented in the XML form.

### Example 2

<TestCase>

<Value>http://</Value>
<Value Repeat=“50000”>A</Value>

</TestCase>

Meanwhile, since there may be tens of to hundreds of combinations of test input values for testing one method depending on the number of transfer factors of each callable method, the type of each transfer factor, and the input value DBs 310 and 330, it is necessary to adjust the number of input values used for the test depending on a level of a security vulnerability test.

Referring again to FIG. 4, when combinations of test input values are generated, the combinations of test input values are used to generate a test web page in an HTML form that a web browser is able to recognize (S404).

The web browser is executed in a debug mode with respect to the generated web page (S405) to access the test page (S406), and then activities of the test web page are monitored (S407).

In this case, calls are monitored by hooking to a file, a registry, and a network-related API functions to monitor the resource access activity of the web browser. Here, since the ActiveX control is in a DLL form to be loaded to the web browser process and to operate, resource access of the web browser process is monitored.

When the web browser is abnormally terminated while its activities are monitored (S408), a debugging log including register and stack statuses for the process is recorded (S409).

In addition, when a resource access occurs (S410) while the activities of the web browser are monitored, it is determined whether character strings including a magic string are used as a transfer factor of the corresponding API function (S411), and only a case in which the character strings including the magic string are used is considered the resource access, and a resource access log is recorded (S412).

The magic string denotes a character string that is not detected under the general circumstances, and when the magic string is used as an input value for a test, the presence of the corresponding magic string is determined in a monitoring step, and only when the character string used as the input value is detected as it is, the resource access is acknowledged.

Then, based on the debugging log attributable to the abnormal termination of the web browser and the resource access log attributable to the resource access, a vulnerability verification code is generated to record the generated results in a security vulnerability DB 350 (S413).

Therefore, the buffer overflow security vulnerability and the access security vulnerability are classified to generate the vulnerability verification code, and the results are recorded in the security vulnerability DB 350 to detect the security vulnerability in the corresponding ActiveX control.

In this case, the length of character strings is lengthened or shortened to generate an exploit pattern for the buffer overflow security vulnerability, so that the minimum character strings that cause the buffer overflow may be found. In the buffer overflow security vulnerability, abuse of the vulnerability may be determined using the length of the character strings. This is because, unlike the resource access-type vulnerability, the buffer overflow is generated with respect to character strings exceeding the maximum length that an internally implemented code of the ActiveX control is able to normally process.

The security vulnerability DB 350 will be described in greater detail below.

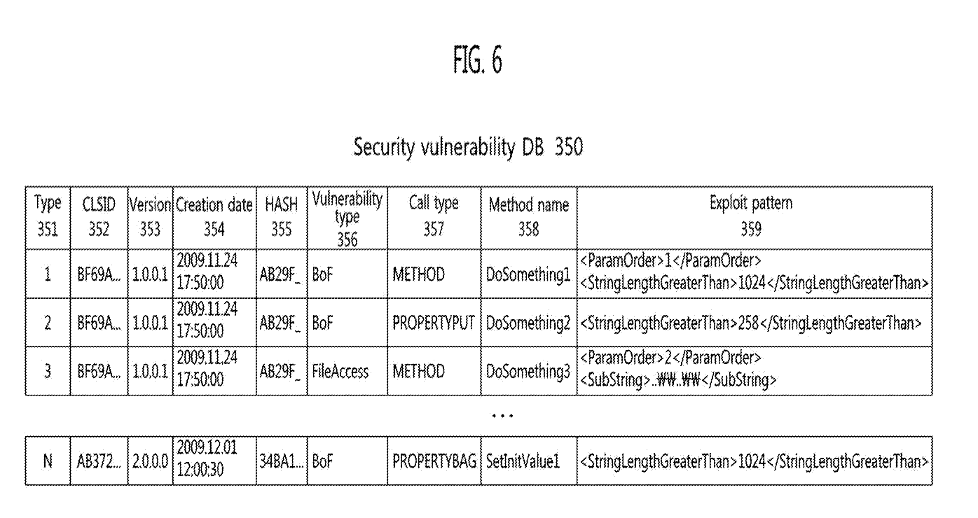

FIG. 6 illustrates an example of a security vulnerability DB 350 used in the present invention.

Referring to FIG. 6, information such as a vulnerability ID 351, CLSID 351, a version 353, a creation date 354, HASH 355, a vulnerability type 356, a call type 357, a method name 358, and an exploit pattern 359 is recorded in the security vulnerability DB 350.

In particular, the vulnerability type 356 is classified into a buffer overflow (BoF) security vulnerability type and a resource access security vulnerability type (FileAccess, RegAccess and NetAccess).

The BoF security vulnerability is obtained by calculating the length of the minimum input value at which the value of Register EIP is changed into Invalid Input among combinations of input values in which Access Violation occurs at a previous step. Here, the length of the calculated minimum input value is used for the generation of the exploit pattern 359 in the security vulnerability DB 350.

Unlike the BoF security vulnerability, the resource access-type security vulnerability is not able to directly control CPU commands, and thus when a file including a magic string affected by an input value is generated, deleted, read, or executed, it is classified as the FileAccess security vulnerability, and when a registry entry including a magic string is generated, deleted or read, it is classified as the RegAccess security vulnerability. Further, when a network access such as an HTTP request including a magic string occurs, it is classified as the NetAccess security vulnerability. The operation of generating a verification code for the resource access-type security vulnerability must begin with a file path including a magic string, a registry path, and a network path prepared in advance. However, in the NetAccess security vulnerability, additional operations occur depending on a file downloaded from the network path, and thus it is difficult to perform the verification completely using an automatic method. Other than the NetAccess, the RegAccess and the FileAccess may be verified using the automatic method.

Here, in the BoF, while an exploit pattern is generated on the basis of the minimum character strings that generate the buffer overflow, an exploit pattern with respect to the resource access-type security vulnerability may be generated using only character strings such as “..\\..\\” for Directory Traversal. This is because the use of the exploit pattern allows the normal use of the ActiveX control in a user PC, and blocks only the exploit pattern.

That is, a value that is not used during the normal use must be indicated as the exploit pattern 359 generated in the vulnerability verification code generating step (S413). Therefore, the security vulnerability that is not able to generate the exploit pattern 359 is maintained in the security vulnerability DB 350, but is excluded from the exploit pattern 359 transferred to the user PC 500.

The security vulnerability detecting process (S400) is mainly performed in the virtual machine in a Non-Persistent mode.

That is, in the security vulnerability detecting process (S400), a test web page is generated on the basis of the combinations of test input values with respect to an ActiveX control installed on a PC to be tested, a web browser is driven to access the generated test web page, and an operation status and a resource access status of the web browser processor are monitored to automatically detect a security vulnerability in the ActiveX control.

Therefore, according to the security vulnerability detecting process (S400), test input values of various patterns may be applied, and the test may be conducted on the basis of the Internet Explorer having the same environmental conditions as actually used. In addition, security vulnerabilities in the resource access type in addition to the buffer overflow may be detected, and an exploit pattern with respect to the detected security vulnerability may be automatically generated.

(3) ActiveX Control Security Vulnerability Immunizing Process (S600)

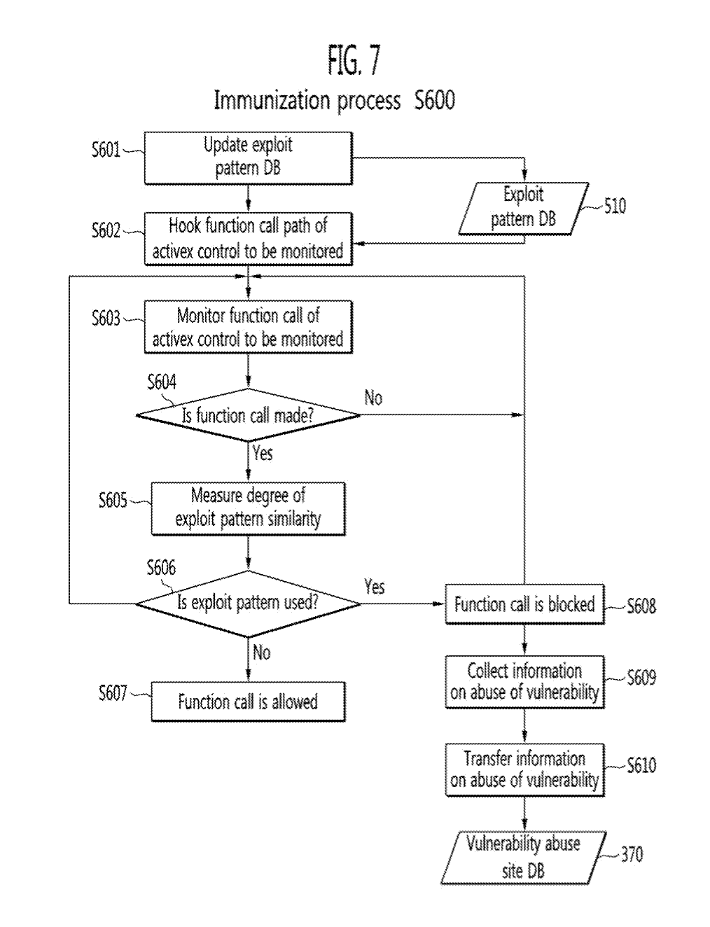

FIG. 7 illustrates a process (S600) of immunizing a security vulnerability in an ActiveX control according to an exemplary embodiment of the present invention.

First, a user PC 500 updates an exploit pattern DB 510 stored in a memory using the exploit pattern 359 of the security vulnerability DB 350 downloaded from the security vulnerability detection server 300 (S601).

In the exploit pattern 510, an exploit pattern that is an abnormal use pattern of the ActiveX control is recorded, and this will be described in greater detail below.

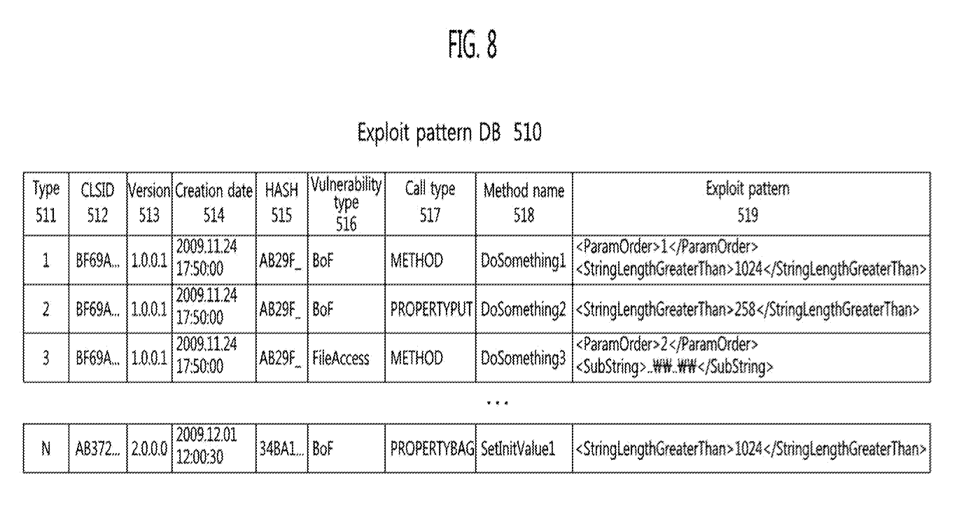

FIG. 8 illustrates an example of an exploit pattern DB 510 used in the present invention.

Referring to FIG. 8, information such as a vulnerability ID 511, CLSID 512, a version 513, a creation date 514, HASH 515, a vulnerability type 516, a call type 517, a method name 518, and an exploit pattern 519 is recorded in the exploit pattern 510.

That is, the security vulnerability DB 350 is downloaded from the security vulnerability detection server 300, and then the exploit pattern DB 510 is updated using the exploit pattern 359 included in the security vulnerability DB 350.

A function call (a method/property call and an initial value input) path of the ActiveX control having a security vulnerability to be monitored is then hooked (S602).

Here, the function call path of the ActiveX control may be hooked by changing an ActiveX control file registered in a registry, changing a table for the corresponding interface or sensing a newly installed ActiveX control.

Next, the function call (a method/property call and an initial value input) of the ActiveX control to be monitored is monitored using the hooked code (S603).

When a function call (a method/property call and an initial value input) of the ActiveX control is made (S604), a degree of similarity between the transfer factor and the exploit pattern with respect to each function call is measured (S605).

Then, the use of the exploit pattern is determined depending on whether the measured degree of similarity exceeds a predefined threshold or not (S606).

When it is determined that the exploit pattern is not used, the function call (a method/property call and an initial value input) is allowed (S607), and when it is determined that the exploit pattern is used, the function call (a method/property call and an initial value input) is blocked (S608).

Here, with respect to the method call, a method may be blocked by returning an error value without calling the original method from the hooked code.

When the use of the exploit pattern causes the function call (a method/property call and an initial value input) to be blocked, information on abuse of a vulnerability is collected (S609), and the collected information is transferred to the security vulnerability detection server 300 with the user's consent.

Here, the information on abuse of a vulnerability transferred to the security vulnerability detection server 300 is recorded in a vulnerability abuse site DB 370, and the vulnerability abuse site DB 370 will be described in greater detail below.

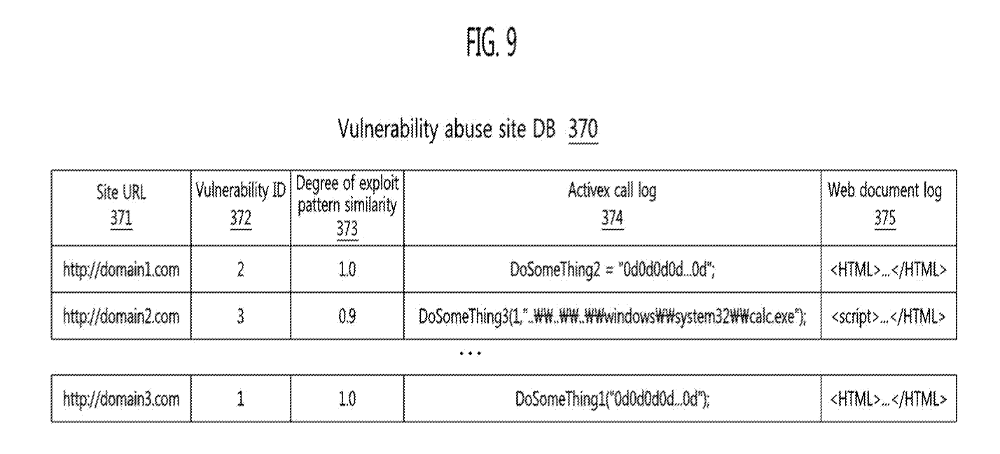

FIG. 9 illustrates an example of a vulnerability abuse site DB 370 used in the present invention.

Referring to FIG. 9, information on abuse of a vulnerability such as a URL of a site abusing a vulnerability 371, a vulnerability ID 372, a degree of exploit pattern similarity 373, an ActiveX call log 374 representing an input value log used in calling a function call of the ActiveX control, and a web document log 375 representing the content of a web document loaded into a web browser when accessing a URL of the corresponding site is recorded in the vulnerability abuse site DB 370, and examples of security vulnerabilities in the ActiveX control being abused may be recognized using the information.

That is, in the vulnerability immunization process S600, each function call (a method/property call and an initial value input) with respect to the ActiveX control included in the exploit pattern DB 510 is monitored, so that a function call of the ActiveX control having a high similarity to the exploit pattern 359 is blocked. Further, the corresponding example of the vulnerabilities being abused is transferred to the security vulnerability detection server 300 with the user's consent to be recorded in the vulnerability abuse site DB 370, so that the abuse of security vulnerabilities is prevented.

Therefore, according to the immunization process S600, it is possible to immediately prevent the abuse of an ActiveX control having a security vulnerability in a user PC.

According to the present invention, a security vulnerability existing in an ActiveX control can be automatically detected, effects brought on by the security vulnerability can be measured, and abuse of the detected security vulnerability in a user PC to be protected can be immediately prevented.

Therefore, since a user PC can be protected regardless of a security patch, it is anticipated that security problems in the Internet environment caused by imprudent use of the ActiveX control can be significantly enhanced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of identifying an ActiveX control distribution site, comprising:
performing a search engine query input from a distribution site identification server to obtain URLs to be tested, and executing a web browser for each of the URLs to access the URLs;
determining whether or not each of the accessed URLs uses an ActiveX control;
collecting information on the ActiveX control and recording the information in a distribution status DB when each accessed URL uses an ActiveX control; and
identifying the ActiveX control distribution site based on the distribution status DB.

2. The method of claim 1, wherein determining whether or not each of the accessed URLs uses an ActiveX control includes analyzing a structure of a document object model (DOM) loaded into a web browser at each of the accessed URLs, and determining whether an ActiveX control is used or not.

3. The method of claim 1, wherein collecting information on the ActiveX control includes collecting a URL of a site where the ActiveX control is used, a URL of an installation file of the ActiveX control, a version, a creation date, a publisher, a hash value for the installation file, and a binary value of the installation file, and recording the collected information together with an identifier in the distribution status DB.

4. The method of claim 1, wherein collecting information on the ActiveX control includes:
checking whether a test scheduling is terminated or not when the ActiveX control is not used in each of the accessing URLs to be tested; and
accessing the URLs to be tested after a designated time lapses and determining whether the ActiveX control is used or not when the test scheduling is not terminated.

5. A method of detecting a security vulnerability in an ActiveX control, comprising:
installing an ActiveX control to be tested from a security vulnerability detection server to a testing PC that operates in a virtual machine;
generating combinations of test input values for testing the ActiveX control;
generating a test web page using the generated combinations of test input values;
executing a web browser to access the generated test web page, monitoring activities of the web browser, and recording a debugging log caused by abnormal termination of the web browser and a resource access log caused by a resource access in a security vulnerability DB; and
detecting a security vulnerability in the ActiveX control based on the security vulnerability DB.

6. The method of claim 5, wherein generating combinations of test input values for testing the ActiveX control includes generating the combinations of test input values for each callable method, property, and initialization using a predefined basic input value DB.

7. The method of claim 6, wherein generating combinations of test input values for testing the ActiveX control includes:
extracting a normal input value for each method and transfer factor from a normal web site using an ActiveX control to be tested and recording the extracted results in a control-specific input value DB; and
generating the combinations of test input values for each callable method, property, and initialization using the basic input value DB and the control-specific input value DB.

8. The method of claim 7, wherein an input value type of the ActiveX control, a test input value type for testing the ActiveX control, and a value representing the test input value in an XML format are recorded in the basic input value DB and the control-specific input value DB.

9. The method of claim 8, wherein the test input value type is classified into Invalid Input having an extreme value not used under normal circumstances so that the presence of the security vulnerability is determined, and Code Coverage that is a value forming every condition enabling entry up to a code point where the security vulnerability occurs due to the Invalid Input value.

10. The method of claim 5, wherein executing the web browser includes recording a debugging log including register and stack statuses for a process when the web browser is abnormally terminated while the activities of the web browser are monitored.

11. The method of claim 5, wherein executing the web browser includes determining whether or not a character string including a magic string is used as a transfer factor of a corresponding API function when the web browser accesses a resource while the activities of the web browser are monitored, and recognizing resource access only when a character string including a magic string is used, and recording a resource access log.

12. The method of claim 11, further comprising hooking a file, a registry, and network-related API functions to monitor resource access activities of the web browser.

13. The method of claim 5, wherein executing the web browser includes recording a vulnerability type of the vulnerability in the ActiveX control, a call type, a method name, and an exploit pattern representing an abnormal use pattern of the ActiveX control together with a vulnerability identifier in the security vulnerability DB.

14. The method of claim 13, wherein the vulnerability type is classified into a buffer overflow security vulnerability type and a resource access security vulnerability type,
the vulnerability type is classified as the buffer overflow security vulnerability type when the length of a minimum input value at which a register EIP is changed into Invalid Input among the combinations of input values that cause Access Violation is calculated, and
the vulnerability type is classified as FileAccess security vulnerability of the resource access-type security vulnerability when a file including a magic string affected by an input value is generated, deleted, read, or executed, as RegAccess security vulnerability when a registry entry including a magic string is generated, deleted or read, and as NetAccess security vulnerability when a network access including a magic string occurs.

15. A method of immunizing a security vulnerability in an ActiveX control, comprising:
updating an exploit pattern DB in which an exploit pattern that is an abnormal use pattern of an ActiveX control at a user PC is recorded, and hooking a function call path of an ActiveX control to be monitored;
monitoring a call of a function of the ActiveX control to be monitored using the hooked code;
measuring a degree of similarity between a transfer factor and the exploit pattern with respect to each function call when the function call of the ActiveX control to be monitored is made;
determining use of the exploit pattern and interrupting the function call when the measured degree of similarity exceeds a predefined threshold, and determining non-use of the exploit pattern and allowing the function call when the measured degree of similarity does not exceed a predefined threshold; and
collecting information on abuse of a vulnerability and transferring the collected information to a security vulnerability detection server when the use of the exploit pattern causes the function call to be blocked.

16. The method of claim 15, wherein updating the exploit pattern DB includes downloading a security vulnerability DB from the security vulnerability detection server and updating the exploit pattern DB using the exploit pattern included in the security vulnerability DB.

17. The method of claim 15, wherein monitoring the call function of the ActiveX control to be monitored includes changing an ActiveX control file registered in a registry, changing a table for a corresponding interface, or sensing a newly installed ActiveX control to hook a function call path of the ActiveX control.

18. The method of claim 16, further comprising recording a URL of a site abusing a vulnerability, a vulnerability ID, a degree of exploit pattern similarity, an ActiveX control call log representing an input value log used when a function call of the ActiveX control is made, and a web document log representing the content of a web document loaded into a web browser when the URL of the site is accessed in the vulnerability abuse site DB based on the information on abuse of a vulnerability transferred from the security vulnerability detection server.
